(19) United States
(12) Patent Application Publication
(10) Pub. No.: US 2023/0367159 A1
(43) Pub. Date: Nov. 16, 2023

(54) LIQUID CRYSTAL DISPLAY PANEL

(71) Applicant: Sharp Display Technology Corporation, Kameyama City (JP)

(72) Inventors: Takahiro KOSHIBA, Kameyama City (JP); Hiroto AKIYAMA, Kameyama City (JP)

(21) Appl. No.: 18/141,237

(22) Filed: Apr. 28, 2023

(30) Foreign Application Priority Data
May 16, 2022 (JP) 2022-080167

(51) Int. Cl. G02F 1/1362; G02F 1/1368

(52) U.S. Cl. CPC G02F 1/136222; G02F 1/136286; G02F 1/136209; G02F 1/1368

(57) ABSTRACT

A liquid crystal display panel includes an active matrix substrate, a color filter substrate, and a liquid crystal layer. The color filter substrate includes a black matrix that include a plurality of first portions that each overlap a plurality of source bus lines of the active matrix substrate in plan view and a plurality of second portions that intersect the plurality of first portions and each overlap a plurality of gate bus lines of the active matrix substrate in plan view, and a plurality of spacers. Of the plurality of first portions, a first portion that is adjacent to at least part of the plurality of spacers has a base portion. A width of the base portion in a direction perpendicular to a direction in which the first portion extends is larger than a width of other portions.

### BACKGROUND

### 1. Field

The present disclosure relates to a liquid crystal display panel.

### 2. Description of the Related Art

There is known a liquid crystal display panel in which spacers that are columnar in form are provided to maintain a fixed thickness of a liquid crystal layer. In such a liquid crystal display panel, applying a large force thereto causes deformation of the liquid crystal display panel, and tip ends of the spacers that are columnar in form come into contact with an alignment film and cause disturbance in alignment of the liquid crystal, which can lead to occurrence of light leakage. Japanese Unexamined Patent Application Publication No. 2011-186279 discloses providing light-shielding regions in regions adjacent to the spacers that are columnar in form to address this problem.

It is desirable to provide a liquid crystal panel that enables occurrence of light leakage due to deformation under external force to be suppressed.

### SUMMARY

A liquid crystal display panel according to an embodiment of the present disclosure includes an active matrix substrate, a color filter substrate disposed so as to oppose the active matrix substrate, and a liquid crystal layer positioned between the active matrix substrate and the color filter substrate. The active matrix substrate includes a first substrate that is transparent, a plurality of gate bus lines that are positioned on the first substrate and that extend in a first direction, a plurality of source bus lines that are positioned on the first substrate and that intersect the plurality of gate bus lines and extend in a second direction, a plurality of pixels that are two-dimensionally arrayed in the first direction and the second direction, and that are each electrically connected to one of the plurality of gate bus lines and one of the plurality of source bus lines, and a first alignment film that is disposed on the first substrate so as to cover the plurality of gate bus lines, the plurality of source bus lines, and the plurality of pixels. The color filter substrate includes a second substrate that is transparent, a black matrix that is positioned on the second substrate, and that includes a plurality of first portions that each overlap the plurality of source bus lines of the active matrix substrate in plan view and a plurality of second portions that intersect the plurality of first portions and each overlap the plurality of gate bus lines of the active matrix substrate in plan view, a plurality of color filters that are positioned on the second substrate and that are each disposed in a plurality of regions obtained by sectioning using the plurality of first portions and the plurality of second portions of the black matrix, and a plurality of spacers that are columnar in form, and that are disposed in at least part of a plurality of regions in which the plurality of first portions and the plurality of second portions of the black matrix intersect. Of the plurality of first portions, a first portion that is adjacent to at least part of the plurality of spacers has a base portion that is in contact with one of the second portions, and in the first portion that is adjacent, a width of the base portion in a direction perpendicular to a direction in which the first portion extends is larger than a width of other portions.

### BRIEF DESCRIPTION OF THE DRAWINGS

FIG. 1 is a diagram for describing positional deviation occurring between an active matrix substrate and a color filter substrate due to flexure of a liquid crystal display panel;

FIG. 2 is a schematic perspective view illustrating an external view of a liquid crystal display panel according to an embodiment;

FIG. 3 is a partial enlarged plan view illustrating central components of an active matrix substrate;

FIG. 4 is a partial enlarged plan view illustrating central components of a color filter substrate;

FIG. 5 is a sectional diagram of the liquid crystal display panel, taken along line V-V in FIG. 4;

FIG. 6 is an enlarged plan view illustrating intersecting portions of first portions and a second portion of a black matrix;

FIG. 7 is a schematic diagram for describing suppression of light leakage in the liquid crystal display panel according to the embodiment;

FIG. 8 is a schematic diagram for describing suppression of light leakage in the liquid crystal display panel according to the embodiment;

FIG. 9 is a schematic diagram for describing suppression of light leakage in the liquid crystal display panel according to the embodiment;

FIG. 10 is a schematic diagram for describing occurrence of light leakage in a liquid crystal display panel in the related art; and

FIG. 11 is a schematic diagram for describing occurrence of light leakage in the liquid crystal display panel in the related art.

### DESCRIPTION OF THE EMBODIMENTS

Liquid crystal display panels are used in various usages, and there are cases of demand for low-cost liquid crystal display panels in which part of manufacturing processes are omitted. Specifically, there are cases of demand for liquid crystal panels of which manufacturing costs are suppressed by omitting slimming, in which the thicknesses of glass substrates are reduced, omitting an interlayer insulating film for planarization of an active matrix substrate surface, and so forth.

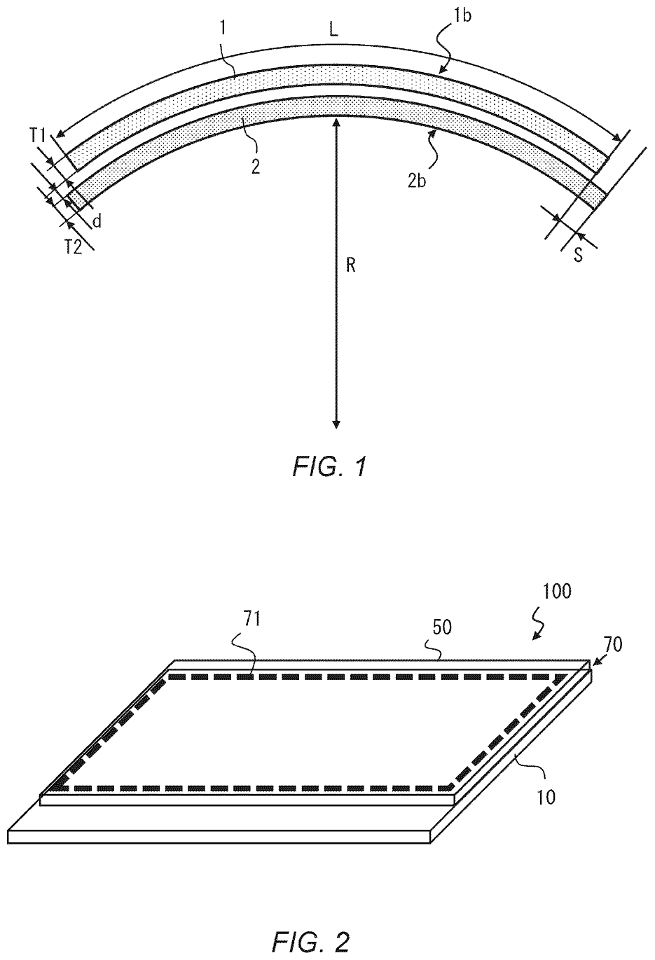

In liquid crystal panels that are not subjected to the slimming process, light leakage, described in the Background section, due to contact between spacers that are columnar in form and an alignment film sometimes occurs pronouncedly due to the glass substrates being thick. The reason thereof will be described with reference to FIG. 1. A state will be considered in which an active matrix substrate 1 and a color filter substrate 2 of a liquid crystal display panel are bent by external force of fingers or the like, as illustrated in FIG. 1. The thickness of the active matrix substrate 1 is denoted by T1, the thickness of the color filter substrate 2 is denoted by T2, and the total thickness of these is denoted by T. Also, the spacing between the active matrix substrate 1 and the color filter substrate 2 is denoted by d. A state will be considered in which the liquid crystal display panel flexes such that a rear face 1b of the active matrix substrate 1 becomes convex, due to external force being applied from the side of the color filter substrate 2 toward the side of the active matrix substrate 1. The radius of flexure at a front face 2b of the color filter substrate 2 is denoted by R here.

In a case in which the length of the liquid crystal display panel with no flexure is denoted by L, positional deviation S is generated between the front face 2b of the color filter substrate 2 and the rear face 1b of the active matrix substrate 1 at each of the ends in FIG. 1, due to the difference in radius between the active matrix substrate 1 and the color filter substrate 2 when the active matrix substrate 1 and the color filter substrate 2 are flexing. In a case in which the radius R is sufficiently large with respect to the sum of T and d, this positional deviation S is expressed by S=L(T+d)/(2R). For example, glass substrates used in liquid crystal display panels normally have a thickness of approximately 400 μm to 500 μm, and the glass substrates are etched down to a thickness of approximately 100 μm to 200 μm in the slimming process. Accordingly, in cases in which the glass substrates are thick, the range of the spacers that are columnar in form come into contact with the alignment film and move due to flexing and deformation under external force is larger, and accordingly the range over which the alignment of the liquid crystal layer is disturbed is also larger.

Also, manufacturing costs of the liquid crystal display panel can be reduced by not planarizing a base when forming the alignment film on the active matrix substrate side. However, studies carried out by the present inventors found that the above-described flexure due to external force can cause light leakage to occur near spacers along the source bus lines in liquid crystal display panels that do not have a planarizing film. The present inventors have conceived a new liquid crystal display panel in light of the foregoing.

An embodiment of the present disclosure will be described below with reference to the drawings. The present disclosure is not limited to the following embodiment, and design alterations may be made as appropriate within a scope that fulfills the configuration of the present disclosure. Also, in the following description, parts that are the same or parts that have similar functions may be denoted by the same symbols throughout different drawings, and repetitive description thereof may be omitted. Also, various configurations described in the embodiment and modifications thereof may be combined as appropriate or may be altered without departing from the essence of the present disclosure. In the drawings which will be referenced below, configurations may be simplified or schematized in illustration, and part of configuration members may be omitted, in order to facilitate understanding of the description. Also, the dimensional ratios among the configuration members illustrated in the drawings do not necessarily indicate actual dimensional ratios.

FIG. 2 is a schematic perspective view illustrating an external view of a liquid crystal display panel according to the present embodiment. The liquid crystal display panel 100 includes an active matrix substrate 10, a color filter substrate 50, and a liquid crystal layer 70.

The active matrix substrate 10 and the color filter substrate 50 are disposed so as to oppose each other. In the present specification, the term “oppose” means to face each other.

The liquid crystal layer 70 is positioned between the active matrix substrate 10 and the color filter substrate 50, and is sealed between the active matrix substrate 10 and the color filter substrate 50 by a seal 71 that is disposed on the perimeter of the liquid crystal layer 70. The liquid crystal display panel 100 is interposed between a pair of polarizing plates disposed in a crossed-Nichols arrangement, with a backlight disposed on the active matrix substrate 10 side, and thus can display images as a liquid crystal display device.

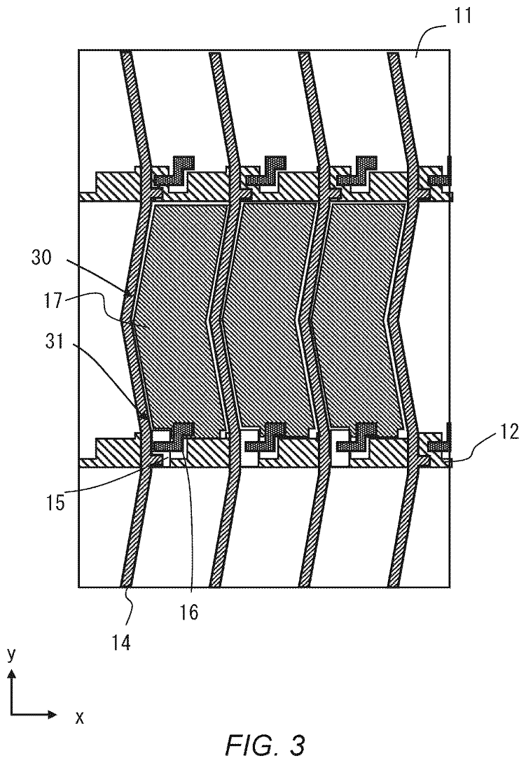

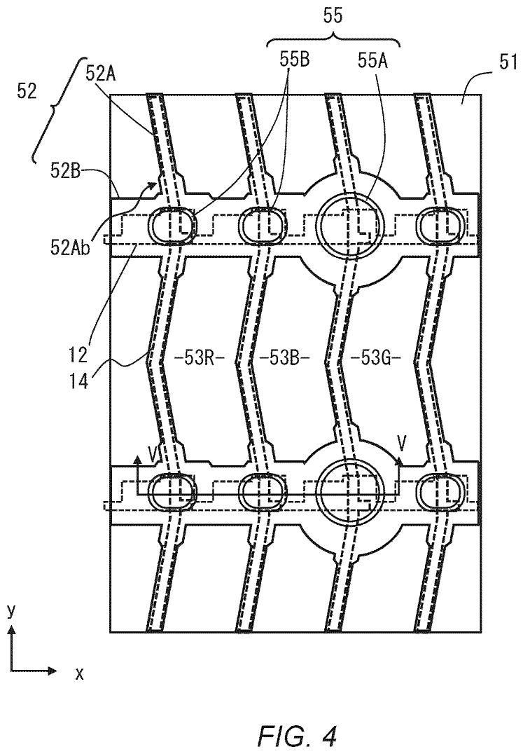

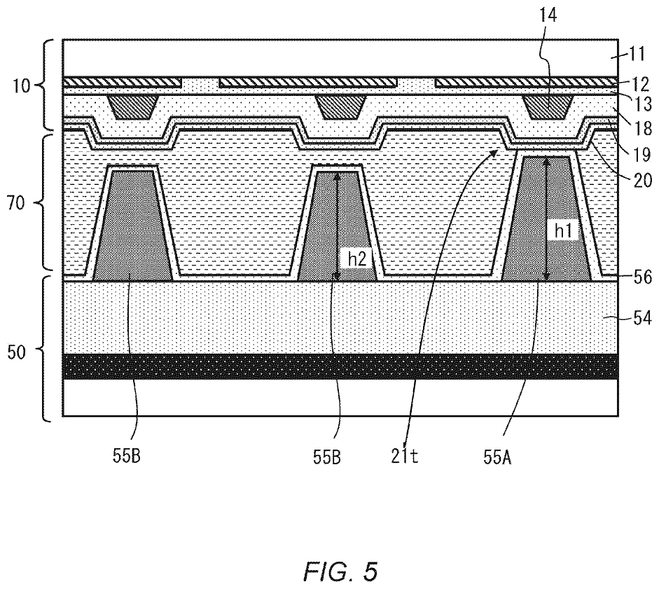

FIG. 3 is a partial enlarged plan view illustrating central components of the active matrix substrate 10, and FIG. 4 is a partial enlarged plan view illustrating central components of the color filter substrate 50. Also, FIG. 5 is a sectional diagram of the liquid crystal display panel 100, taken along line V-V in FIG. 4. Note that in FIG. 4, a structure of the color filter substrate 50 is illustrated as viewed from a face opposite to a face that opposes the liquid crystal layer 70, in order to facilitate understanding of the correlation in the layout of components of the active matrix substrate 10 and the color filter substrate 50.

The active matrix substrate 10 includes a first substrate 11, a plurality of gate bus lines 12, a plurality of source bus lines 14, a plurality of pixels 30, and a first alignment film 20. The active matrix substrate 10 further includes a gate insulating film 13, an interlayer insulating film 18, and a common electrode 19.

The first substrate 11 supports the components formed on the active matrix substrate 10, and is made of a transparent material such as, for example, glass, resin, or the like.

Each of the plurality of gate bus lines 12 extends in an x direction (first direction), arrayed at predetermined spacings in a y direction (second direction). The gate bus lines 12 are made of a metal material, such as, for example, aluminum, copper, titanium, molybdenum, chromium, alloys thereof, and so forth.

The gate insulating film 13 is disposed on the first substrate 11 so as to cover the gate bus lines 12. The gate insulating film 13 is made of an inorganic material, such as silicon oxide, silicon nitride, silicon oxynitride, or the like.

Each of the plurality of source bus lines 14 extends overall in the y direction. The plurality of source bus lines 14 are disposed at predetermined spacings in the x direction. The plurality of source bus lines 14 intersect the plurality of gate bus lines 12, with the gate insulating film 13 interposed therebetween. In the present embodiment, each of the source bus lines 14 has bent portions at intersecting regions with the gate bus lines 12, and partway between two intersecting regions, and the directions in which the source bus lines 14 extend alternate at the bent portions. Accordingly, the source bus lines 14 have an overall zigzag form.

Each of the plurality of pixels 30 is disposed at a region surrounded by a pair of gate bus lines 12 that are adjacent, out of the plurality of gate bus lines 12, and a pair of source bus lines 14 that are adjacent, out of the plurality of source bus lines 14. Each pixel 30 includes a thin-film transistor (TFT) 31 and a pixel electrode 17. Each pixel 30 is electrically connected to one of the pair of gate bus lines 12 and one of the pair of source bus lines 14. Specifically, the TFT 31 includes a semiconductor layer 15 and a drain electrode 16, and overlaps the gate bus line 12 with the gate insulating film 13 interposed therebetween. The semiconductor layer 15 is electrically connected to the source bus lines 14 and the drain electrode 16. The drain electrode 16 is further electrically connected to the pixel electrode 17.

The semiconductor layer 15 includes an oxide semiconductor layer containing at least one selected from the group consisting of indium (In), gallium (Ga), and zinc (Zn), or a silicon (Si) semiconductor layer, for example. The oxide semiconductor layer and the Si semiconductor layer may include various crystallinities, such as polycrystalline, microcrystalline, c-axis orientated, and so forth. The pixel electrode 17 may be made of a transparent electrode material such as, for example, indium tin oxide (ITO), indium zinc oxide (IZO), or the like. The drain electrode 16 may be made of a transparent electrode material, or may be made of a metal material listed as materials for the gate bus lines 12.

The interlayer insulating film 18 is positioned on the first substrate 11 and covers the gate bus lines 12, the source bus lines 14, and the pixels 30. The interlayer insulating film 18 may be made of an inorganic material, such as silicon oxide, silicon nitride, silicon oxynitride, or the like, or may be made of an organic material such as acrylic resin, or the like. As illustrated in FIG. 5, an upper face of the interlayer insulating film 18 has recesses and protrusions corresponding to structures that the interlayer insulating film 18 covers, and the upper face thereof is not planarized. That is to say, the interlayer insulating film 18 is not a planarizing film.

The common electrode 19 is disposed on the first substrate 11 so as to cover the entirety of the interlayer insulating film 18. The common electrode 19 may be made of a transparent electrode material, in the same way as the pixel electrode 17. Although the common electrode 19 is a single solid electrode that is connected over the entirety thereof in the present embodiment, the common electrode 19 may be divided in accordance with each pixel or each plurality of pixels. Also, while the common electrode 19 is positioned closer to the liquid crystal layer 70 than the pixel electrode 17 is in the present embodiment, the common electrode 19 may be positioned closer to the first substrate 11 than the pixel electrode 17 is. In this case, the interlayer insulating film 18 may be positioned between the pixel electrode 17 and the common electrode 19.

Of the pixel electrode 17 and the common electrode 19, the electrode closer to the liquid crystal layer 70 may have slit-like openings provided therein. In the present embodiment, the common electrode 19 may have slit-like openings provided therein.

The first alignment film 20 is disposed on the first substrate 11 so as to cover the entirety of the common electrode 19. The upper face of the interlayer insulating film 18 is not planarized, as described above, and accordingly an upper face of the first alignment film 20 also has recesses and protrusions corresponding to the structures on the first substrate 11. In particular, the first alignment film 20 may have ridges 21t at the source bus lines 14 that protrude toward the color filter substrate 50. The first alignment film 20 is made of polyimide resin, for example, and the surface thereof is subjected to alignment processing such as photo-alignment, rubbing, or the like.

The color filter substrate 50 includes a second substrate 51, a black matrix 52, a plurality of color filters 53, and a plurality of spacers 55 that are columnar in form. The color filter substrate 50 further includes an overcoat layer 54 and a second alignment film 56.

The second substrate 51 supports the components formed on the color filter substrate 50, and is made of a transparent material such as glass, resin, or the like.

The black matrix 52 is positioned on the second substrate 51, and includes a plurality of first portions 52A and a plurality of second portions 52B. The plurality of first portions 52A each overlap the plurality of source bus lines 14 of the active matrix substrate 10 in plan view, i.e., as viewed from a direction perpendicular to the principal face of the second substrate 51. Also, the plurality of second portions 52B each overlap the plurality of gate bus lines 12 of the active matrix substrate 10 in plan view. The plurality of first portions 52A and the plurality of second portions 52B intersect each other.

The first portions 52A each have a base portion 52Ab that comes into contact with the second portions 52B. The width of the base portion 52Ab in a direction perpendicular to the direction in which the first portion 52A extends is larger than the width of other portions, which will be described in detail later. The black matrix 52 is made of a resin material such as black resin or the like that does not readily transmit light, a single-layer metal film of chromium or the like, or a laminated structure made up of a metal layer and a layer made of a metal oxide.

The color filters 53 are positioned on the second substrate 51, and are respectively disposed in a plurality of regions obtained by sectioning using the plurality of first portions 52A and the plurality of second portions 52B of the black matrix 52. Specifically, a red color filter 53R, a green color filter 53G, and a blue color filter 53B are disposed in three regions that are adjacent in the x direction for example, and this combination is disposed in other regions as well, in accordance with a layout such as PenTile, stripes, or the like.

The overcoat layer 54 is positioned on the second substrate 51 so as to cover the color filters 53. The overcoat layer 54 is a dielectric made of a resin material or the like, for example.

The plurality of spacers 55 that are columnar in form are positioned in regions where the first portions 52A and the second portions 52B of the black matrix 52 on the overcoat layer 54 intersect. The plurality of spacers 55 that are columnar in form may include first spacers 55A and second spacers 55B. As illustrated in FIG. 5, a height h1 of the first spacers 55A may be larger than a height h2 of second spacers 55B. Accordingly, when the liquid crystal display panel 100 is in a normal state (a case in which no large external force is being applied), the first spacers 55A are in contact with the ridges 21t positioned at the source bus lines 14 of the active matrix substrate 10, and the second spacers 55B are away from apices of the ridges 21t. The spacers 55 can be made of photoresist, for example.

When a large external force is locally applied to the liquid crystal display panel, the first spacers 55A are first compressed, and thereafter the second spacers 55B come into contact with the ridges 21t and receive the external force. Accordingly, a situation in which the first spacers 55A are greatly deformed and exhibit plastic deformation is suppressed, and the first spacers 55A and the second spacers 55B more readily return to the original height when the external force is removed. Also, when the liquid crystal display panel 100 is kept at a low temperature, the first spacers 55A are compressed by contraction of the liquid crystal, and the thickness of the liquid crystal layer 70 of the liquid crystal display panel 100 decrease in accordance with contraction of the liquid crystal. Accordingly, low-temperature air bubbles can be suppressed from being generated at low temperatures.

The second alignment film 56 is disposed on the overcoat layer 54, so as to cover the spacers 55. The second alignment film 56 is made of, for example, a polyimide resin or the like, and a surface thereof is subjected to alignment processing such as photo-alignment, rubbing, or the like.

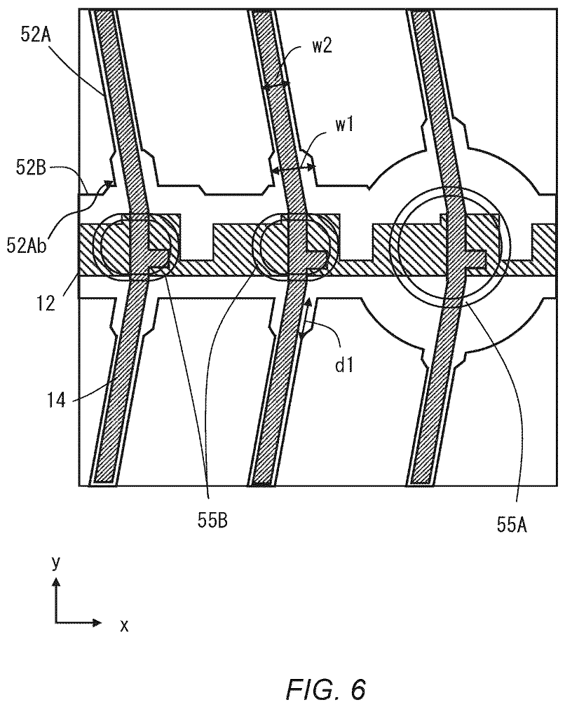

Next, a form of the black matrix 52 will be described in detail with reference to FIG. 6. FIG. 6 is an enlarged plan view illustrating intersecting portions of the first portions 52A and second portion 52B of the black matrix 52. The gate bus lines 12 and the source bus lines 14 are illustrated as well.

The width is defined in a direction perpendicular to the direction in which the first portions 52A extend. A width w1 of the base portion 52Ab of the first portion 52A and a width w2 of other portions positioned closer to a distal end than the base portion 52Ab is may satisfy a relation of the following (1).

w2<w1<2·w2 (1)

Satisfying this relation enables suppression of an excessive increase in the width of the base portion 52Ab and suppression of a large reduction in the aperture ratio, while effectively suppressing light leakage at regions near the spacers along the source bus lines 14.

Also, a length d1 of the base portion 52Ab along the first portion 52A may be larger than the width w1 of the base portion 52Ab. That is to say, the relation of the following (2) may be satisfied.

w2<d1 (2)

Satisfying this relation enables suppression of a large reduction in the aperture ratio even when the liquid crystal display panel is thick, while effectively suppressing light leakage at regions near the spacers along the source bus lines 14.

Further, when the thickness of the liquid crystal display panel 100 is denoted by d2, the relation of the following (3) may be satisfied.

1/200·d2<d1< 1/50·d2 (3)

As described above, there is a correlation between the thickness of the liquid crystal display panel and the positional deviation between the active matrix substrate and the color filter substrate when the liquid crystal panel flexes. Satisfying this relation enables an appropriate positional deviation amount corresponding to the thickness of the liquid crystal display panel 100 to be estimated, which enables the aperture ratio to be kept as high as possible, while effectively suppressing light leakage at regions near the spacers along the source bus lines 14.

Note that while the base portions 52Ab are provided in all first portions 52A adjacent to the first spacers 55A and the second spacers 55B in the example illustrated in FIG. 6, an arrangement may be made in which the base portions 52Ab are provided only in part of the first portions 52A. For example, in a case in which a large area is secured for the area of the black matrix 52 where the first spacers 55A are positioned at intersecting regions of the first portions 52A and the second portions 52B, the base portions 52Ab do not have to be provided.

Specifically, the first spacers 55A are in contact with the first alignment film 20 of the active matrix substrate 10 in a state in which no external force is applied, and accordingly, when external force is applied to the liquid crystal display panel 100, the first spacers 55A come into contact with the first alignment film 20, and move largely while disturbing the surface of the first alignment film 20. Accordingly, the area of the black matrix 52 may be formed so as to be large in advance where the first spacers 55A are disposed at intersecting regions of the first portions 52A and the second portions 52B. In this case, the base portions 52Ab do not have to be provided as long as the distance of movement of the first spacers 55A due to deformation of the liquid crystal display panel 100 is within the range of the black matrix 52 covering the intersecting regions of the first portions 52A and the second portions 52B.

Also, in a case in which the direction of movement of the spacers 55 when the liquid crystal display panel 100 is deformed under external force is determined in accordance with the position within the liquid crystal display panel 100, the base portions 52Ab do not have to be provided in directions in which the spacers 55 will not move.

The liquid crystal display panel 100 can be manufactured by the same method as liquid crystal display panels in the related art, by providing the base portions 52Ab to a mask pattern for forming the black matrix 52.

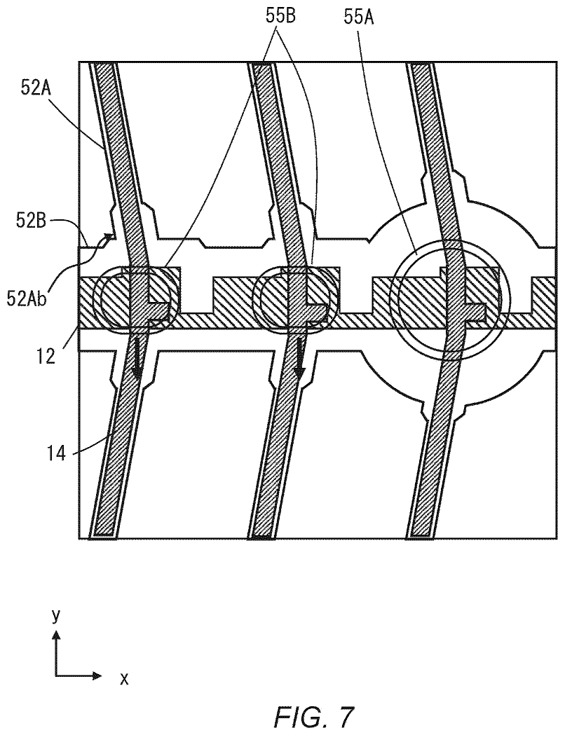

Next, the reason why light leakage at regions near the spacers along the source bus lines 14 is suppressed in the liquid crystal display panel 100 will be described. FIG. 7 illustrates the gate bus lines 12 and the source bus lines 14 positioned on the active matrix substrate 10, and the black matrix 52 and the second spacers 55B positioned on the color filter substrate 50. The positional deviation occurring between the color filter substrate 50 and the active matrix substrate 10 can be divided into, for example, the x direction in which the gate bus lines 12 extend, and the y direction in which the source bus lines 14 extend. Of these, even if the second spacers 55B move in the x direction with respect to the active matrix substrate 10 by positional deviation in the x direction, regions in which scratching, disturbance, and so forth occur at the surface of the first alignment film 20 of the active matrix substrate 10 each overlap the second portions 52B of the black matrix 52 in plan view. Accordingly, movement of the second spacers 55B in the x direction does not readily cause light leakage.

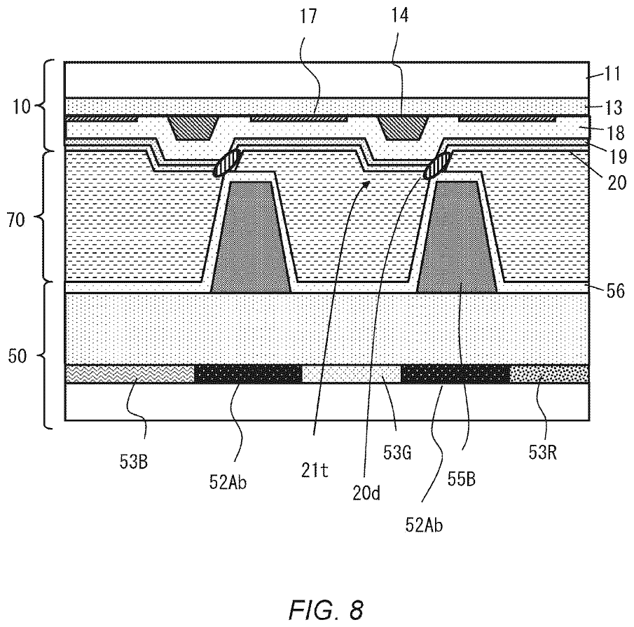

On the other hand, in a case in which the color filter substrate and the second spacers 55B move in the y direction under external force, as indicated by arrows in FIG. 7, apices of the second spacers 55B come into contact with upper faces, corners, and side face portions adjacent to the upper faces, of the ridges 21t formed on the source bus lines 14, as illustrated in FIG. 8, thereby generating regions 20d in which scratching, disturbance, and so forth occur at the first alignment film 20 at such portions.

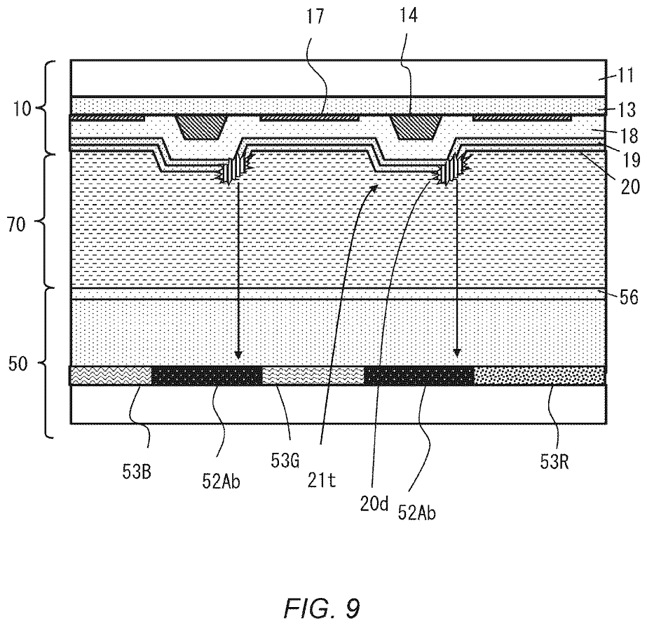

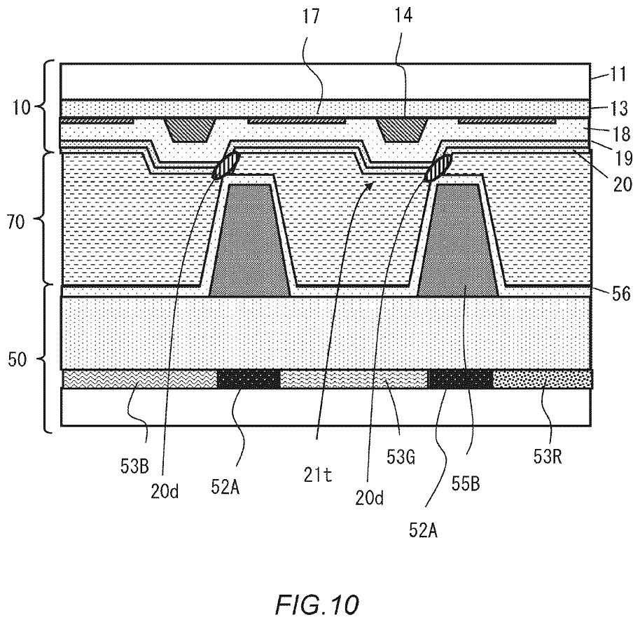

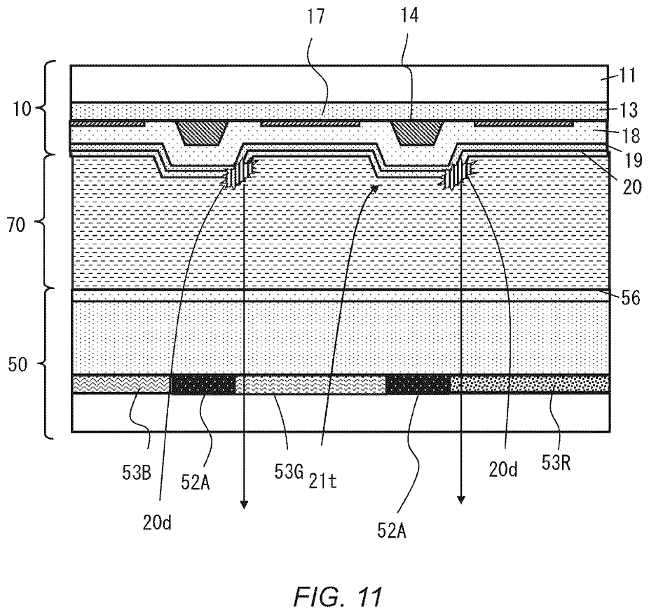

Upon the external force being removed, the color filter substrate 50 returns to the original position, as illustrated in FIG. 9. At this time, the regions 20d each overlap the base portions 52Ab, and accordingly even though disturbance occurs in the liquid crystal layer 70 and light leakage occurs in the regions 20d in which scratching, disturbance, and so forth occur, the light is effectively blocked by the base portions 52Ab. Accordingly, light leakage at regions near the spacers along the source bus lines 14 is suppressed. Conversely, in a case in which the first portions 52A of the black matrix 52 do not have the base portions 52Ab as illustrated in FIGS. 10 and 11, at least part of the regions 20d extends beyond the first portions 52A when the color filter substrate 50 returns to the original position, as illustrated in FIG. 11. Thus, in a case in which disturbance occurs in the liquid crystal layer 70 and light leakage occurs at the regions 20d, it is conceivable that the first portions 52A of the black matrix will not completely block the light leakage, and leaking light will be externally emitted from the color filter substrate 50.

Thus, according to the liquid crystal display panel of the present embodiment, the presence of the base portions 52Ab can effectively suppress light leakage even when the first alignment film 20 near root portions of the source bus lines 14 comes into contact with the spacers 55 and alignment of the liquid crystal is disturbed.

The liquid crystal display panel according to the present disclosure is not limited to the above embodiment, and various modifications may be made. The problem addressed by the liquid crystal display panel according to the present disclosure is particularly pronounced in liquid crystal display panels in a transverse electric field mode, and accordingly the technique according to the present disclosure can be suitably used in liquid crystal display panels employing in-plane switching (IPS), fringe field switching (FFS), and so forth. However, the liquid crystal display panel according to the present disclosure is not limited to liquid crystal display panels in a transverse electric field mode, and may be applied in liquid crystal display panels in a vertical electric field mode. Also, the form of the black matrix illustrated in the present embodiment is exemplary, and the black matrix may have other forms. The configuration of the liquid crystal display panel is also exemplary, and the liquid crystal display panel according to the present disclosure can be applied to liquid crystal display panels of various types of structures. The liquid crystal display panel according to the present disclosure can also be described as follows.

A liquid crystal display panel according to a first configuration includes an active matrix substrate, a color filter substrate disposed so as to oppose the active matrix substrate, and a liquid crystal layer positioned between the active matrix substrate and the color filter substrate. The active matrix substrate includes a first substrate that is transparent, a plurality of gate bus lines that are positioned on the first substrate and that extend in a first direction, a plurality of source bus lines that are positioned on the first substrate and that intersect the plurality of gate bus lines and extend in a second direction, a plurality of pixels that are two-dimensionally arrayed in the first direction and the second direction, and that are each electrically connected to one of the plurality of gate bus lines and one of the plurality of source bus lines, and a first alignment film that is disposed on the first substrate so as to cover the plurality of gate bus lines, the plurality of source bus lines, and the plurality of pixels. The color filter substrate includes a second substrate that is transparent, a black matrix that is positioned on the second substrate, and that includes a plurality of first portions that each overlap the plurality of source bus lines of the active matrix substrate in plan view and a plurality of second portions that intersect the plurality of first portions and each overlap the plurality of gate bus lines of the active matrix substrate in plan view, a plurality of color filters that are positioned on the second substrate and that are each disposed in a plurality of regions obtained by sectioning using the plurality of first portions and the plurality of second portions of the black matrix, and a plurality of spacers that are columnar in form, and that are disposed in at least part of a plurality of regions in which the plurality of first portions and the plurality of second portions of the black matrix intersect. Of the plurality of first portions, a first portion that is adjacent to at least part of the plurality of spacers has a base portion that is in contact with one of the second portions, and in the first portion that is adjacent, a width of the base portion in a direction perpendicular to a direction in which the first portion extends is larger than a width of other portions. According to the first configuration, the presence of the base portion enables light leakage to be suppressed even when the alignment film near root portions of the source bus lines comes into contact with the spacers and alignment of the liquid crystal is disturbed.

In a liquid crystal display panel according to a second configuration, in the first configuration, a relation of w2<w1<2·w2 may be satisfied where w1 represents the width of the base portion and w2 represents the width of the other portions. By the width of the base portion satisfying this relation, light leakage can be efficiently suppressed, while suppressing an increase in the area of the black matrix and a reduction in the aperture ratio.

In a liquid crystal display panel according to a third configuration, in the first configuration, a relation of 0.5·d2<d1<d2 may be satisfied where d1 represents a length of the base portion along the first portion, and d2 represents a thickness of the liquid crystal display panel. By the length of the base portion satisfying this relation, light leakage can be efficiently suppressed, while suppressing an increase in the area of the black matrix and a reduction in the aperture ratio.

In a liquid crystal display panel according to a fourth configuration, in the first configuration, a length of the base portion along the first portion may be larger than the width of the base portion. By the width of the base portion satisfying this relation, light leakage can be efficiently suppressed, while suppressing an increase in the area of the black matrix and a reduction in the aperture ratio.

In a liquid crystal display panel according to a fifth configuration, in any one of the first to fourth configurations, the plurality of spacers may include a first spacer and a second spacer, and a height of the second spacer may be smaller than a height of the first spacer.

In a liquid crystal display panel according to a sixth configuration, in the fifth configuration, the first portion that has the base portion may be adjacent to the second spacer.

In a liquid crystal display panel according to a seventh configuration, in any one of the first to sixth configurations, a surface of the first alignment film may protrude toward the color filter substrate at the plurality of source bus lines.

In a liquid crystal display panel according to an eighth configuration, in any one of the first to seventh configurations, each of the plurality of pixels may include a TFT that is electrically connected to one of the plurality of gate bus lines and one of the plurality of source bus lines, and a pixel electrode that is connected to the TFT.

In a liquid crystal display panel according to a ninth configuration, in the eighth configuration, the active matrix substrate may further include a common electrode and an interlayer insulating film that are disposed between the first substrate and the first alignment film, and the interlayer insulating film may be positioned between the common electrode and a plurality of pixel electrodes, each of which being the pixel electrode that is connected to the TFT.

In a liquid crystal display panel according to a tenth configuration, in any one of the first to ninth configurations, the active matrix substrate may not have a planarizing film positioned between the first alignment film and the first substrate.

The liquid crystal display panel according to the present disclosure can be used in various types of usages, and be suitably used in liquid crystal display panels of various types of driving methods.

The present disclosure contains subject matter related to that disclosed in Japanese Priority Patent Application JP 2022-080167 filed in the Japan Patent Office on May 16, 2022, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display panel, comprising:
an active matrix substrate;
a color filter substrate disposed so as to oppose the active matrix substrate; and
a liquid crystal layer positioned between the active matrix substrate and the color filter substrate, wherein
the active matrix substrate includes
a first substrate that is transparent,
a plurality of gate bus lines that are positioned on the first substrate and that extend in a first direction,
a plurality of source bus lines that are positioned on the first substrate and that intersect the plurality of gate bus lines and extend in a second direction,
a plurality of pixels that are two-dimensionally arrayed in the first direction and the second direction, and that are each electrically connected to one of the plurality of gate bus lines and one of the plurality of source bus lines, and
a first alignment film that is disposed on the first substrate so as to cover the plurality of gate bus lines, the plurality of source bus lines, and the plurality of pixels,
the color filter substrate includes
a second substrate that is transparent,
a black matrix that is positioned on the second substrate, and that includes
a plurality of first portions that each overlap the plurality of source bus lines of the active matrix substrate in plan view, and
a plurality of second portions that intersect the plurality of first portions and each overlap the plurality of gate bus lines of the active matrix substrate in plan view,
a plurality of color filters that are positioned on the second substrate and that are each disposed in a plurality of regions obtained by sectioning using the plurality of first portions and the plurality of second portions of the black matrix, and
a plurality of spacers that are columnar in form, and that are disposed in at least part of a plurality of regions in which the plurality of first portions and the plurality of second portions of the black matrix intersect, and
of the plurality of first portions, a first portion that is adjacent to at least part of the plurality of spacers has a base portion that is in contact with one of the second portions, and in the first portion that is adjacent, a width of the base portion in a direction perpendicular to a direction in which the first portion extends is larger than a width of other portions.

2. The liquid crystal display panel according to claim 1, wherein a relation of
w2<w1<2·w2
is satisfied where w1 represents the width of the base portion and w2 represents the width of the other portions.

3. The liquid crystal display panel according to claim 1, wherein a length of the base portion along the first portion is larger than the width of the base portion.

4. The liquid crystal display panel according to claim 1, wherein the plurality of spacers include a first spacer and a second spacer, and a height of the second spacer is smaller than a height of the first spacer.

5. The liquid crystal display panel according to claim 4, wherein the first portion that has the base portion is adjacent to the second spacer.

6. The liquid crystal display panel according to claim 1, wherein a surface of the first alignment film protrudes toward the color filter substrate at the plurality of source bus lines.

7. The liquid crystal display panel according to claim 1, wherein each of the plurality of pixels includes a thin-film transistor (TFT) that is electrically connected to one of the plurality of gate bus lines and one of the plurality of source bus lines, and a pixel electrode that is connected to the TFT.

8. The liquid crystal display panel according to claim 7, wherein
the active matrix substrate further includes a common electrode and an interlayer insulating film that are disposed between the first substrate and the first alignment film, and
the interlayer insulating film is positioned between the common electrode and a plurality of pixel electrodes, each of which being the pixel electrode that is connected to the TFT.

9. The liquid crystal display panel according to claim 1, wherein the active matrix substrate does not have a planarizing film positioned between the first alignment film and the first substrate.
